(19) United States
(12) Patent Application Publication
(10) Pub. No.: US 2007/0193057 A1
(43) Pub. Date: Aug. 23, 2007

(54) Rotatable vacuum transfer roll apparatus

(76) Inventor: Paul A. Girolamo, Clinton, WI (US)

Correspondence Address: DAVID J. ARCHER, 7037 POMERY ROAD, ROCKTON, IL, 61072, US

(21) Appl. No.: 11/698,669

(22) Filed: Jan. 26, 2007

Related U.S. Application Data
(60) Provisional application No. 60/762,287, filed on Jan. 26, 2006.

(51) Int. Cl. D06F 58/00; F26B 3/00

(52) U.S. Cl. 34/114; 34/453

(57) ABSTRACT

A rotatable vacuum transfer roll apparatus is disclosed for disposition thereof between an upstream and a downstream rotatable dryer of a drying section for drying a web supported by a drying felt. The apparatus includes a cylindrical shell having an inner surface which defines an elongate enclosure. The shell also defines a plurality of holes such that when the enclosure is connected to a vacuum source, air flows from the web through the felt and through the holes into the enclosure. The first and second ends of the shell are selectively connected to the vacuum source and a baffle is disposed within the enclosure for dividing the enclosure into a main chamber and a threading chamber. The arrangement is such that vacuum is applied within the threading chamber for urging the tail of the web into close conformity with the shell.

### CROSS REFERENCE TO RELATED APPLICATION

The present application is a Complete application pursuant to Provisional application U.S. Ser. No. 60/762,287 filed Jan. 26, 2006. All the disclosure of the aforementioned application is incorporated herein by reference.

### BACKGROUND OF THE INVENTION

1. Field of the Invention

The present invention relates to a rotatable vacuum transfer roll apparatus.

More specifically, the present invention relates to a rotatable vacuum transfer roll apparatus for disposition thereof between an upstream and a downstream rotatable dryer of a drying section for drying a web supported by a drying felt.

2. Background Information

In the paper making art, when a web has been pressed, such web is guided around a plurality of drying cylinders for removing most of the remaining moisture from the pressed web.

Many drying cylinders are arranged in groups of dryers with a rotatable transfer roll disposed between adjacent drying cylinders. A drying felt extends in a sinusoidal path around an upstream dryer to a transfer roll and around a downstream dryer. The web to be dried is disposed between the drying felt and the heated surface of the upstream dryer. However, the drying felt is disposed between the web and the outer surface of the transfer roll as the web extends around and is guided by the transfer roll. Also, the web is disposed between the drying felt and the heated surface of the downstream dryer as the web extends around the downstream dryer.

During a threading operation, a tail cutter cuts the web in a machine direction so that a tail approximately 6 inches in width is generated adjacent to a front side of the drying section. The tail may be 30 or more feet in length. The forward end of the tail is threaded around an upstream dryer, an adjacent transfer roll and then around an adjacent downstream dryer. The remainder of the width of the web is returned to the broke pit as the forward end of the tail is progressively threaded along the drying section and onto succeeding drying sections.

The present invention provides a unique transfer roll that assists in the threading of the tail along a drying section. According to the present invention, a threading chamber is provided adjacent to the front side of the drying section so that when a vacuum is applied to the threading chamber, the tail adjacent to the threading chamber is progressively threaded as the tail leaves an upstream dryer and proceeds around the threading chamber of the transfer roll towards the adjacent downstream dryer.

The transfer roll according to the present invention is particularly useful when threading a drying section in which the pocket above the transfer roll and between the upstream and downstream dryers is occupied by a blow box or the like. Blow boxes are provided for minimizing web flutter when the drying machine is operating at high speeds. However, the disposition of the blow boxes hampers easy threading of the tail through a drying section. The provision of the threading chamber according to the present invention facilitates automatic threading of a tail particularly when access to the dryers and transfer roll is limited by the provision of blow boxes and the like.

Therefore, it is a primary feature of the present invention to provide a rotatable vacuum transfer roll apparatus that overcomes the problems associated with the prior art arrangements.

Another feature of the present invention is the provision of a rotatable vacuum transfer roll apparatus that enables automatic threading of a tail of a web.

Other features and advantages of the present invention will be readily apparent to those skilled in the art by a consideration of the detailed description of a preferred embodiment of the present invention contained herein.

### SUMMARY OF THE INVENTION

The present invention relates to a rotatable vacuum transfer roll apparatus. The transfer roll apparatus is disposed between an upstream and a downstream rotatable dryer of a drying section for drying a web supported by a drying felt. The apparatus includes a cylindrical shell having a first and a second end. The shell defines an inner and an outer surface, the inner surface defining an elongate enclosure which extends from the first to the second end of the shell. The shell also defines a plurality of holes with each of the holes extending from the inner to the outer surface of the shell. The arrangement is such that when the enclosure is connected to a vacuum source, air flows from the web through the felt and through the holes into the enclosure. Accordingly, the web is urged against the felt and into close conformity with the shell when the web supported by the felt moves from the upstream dryer around the shell and onto the downstream dryer. The first end of the shell is selectively connected to the vacuum source and a valve is disposed between the vacuum source and the first end of the shell for controlling vacuum applied to the enclosure. Also, the second end of the shell is selectively connected to the vacuum source and a further valve is disposed between the vacuum source and the second end of the shell for controlling vacuum applied to the enclosure. A baffle is disposed within the enclosure between the first and second end of the shell for dividing the enclosure into a main chamber and a threading chamber. The arrangement is such that in operation of the apparatus, threading of a tail of the web from the upstream dryer around the shell and onto the downstream dryer is achieved by opening the valve and closing the further valve so that vacuum is applied within the threading chamber for urging the tail of the web into close conformity with the shell disposed adjacent to the threading chamber. When the tail has been threaded, the further valve is opened so that both valves are open. The arrangement is such that vacuum is applied to both the threading chamber and to the main chamber so that as the tail is widened to a full width of the web, the full width of the web is urged into close conformity with the shell between the first and second ends of the shell.

In a more specific embodiment of the present invention, the enclosure is of cylindrical configuration.

Also, a plurality of circumferential grooves are defined by the outer surface with each of the grooves being spaced axially relative to an adjacent groove.

More specifically, each groove extends radially inwardly relative to the outer surface of the shell with each groove being connected to at least one of the holes.

Moreover, a first journal is secured to the first end of the shell and a first bearing is provided for rotatably supporting the first journal. A second journal is secured to the second end of the shell and a second bearing is provided for rotatably supporting the second journal.

Furthermore, the first journal defines a first conduit which extend from the threading chamber for connecting the threading chamber to the valve. Additionally, the second journal defines a second conduit which extend from the main chamber for connecting the main chamber to the further valve.

The baffle seals the threading chamber from the main chamber, the baffle being of circular disc shaped configuration.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a rotatable vacuum transfer roll apparatus according to the present invention;

FIG. 2 is a perspective view of the cylindrical shell shown in FIG. 1;

FIG. 3 is a side elevational view of the shell shown in FIGS. 1 and 2; and

FIG. 4 is a similar view to that shown in FIG. 3 but shows how threading of a tail of the web is accomplished.

Similar reference characters refer to similar parts throughout the various views of the drawings.

### DETAILED DESCRIPTION OF THE DRAWINGS

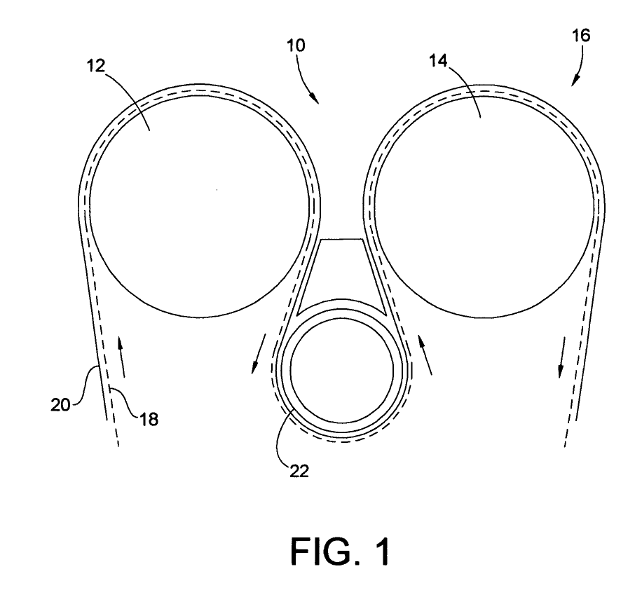

FIG. 1 is a side elevational view of a rotatable vacuum transfer roll apparatus generally designated 10 according to the present invention. As shown in FIG. 1, the apparatus 10 is disposed between an upstream and a downstream rotatable dryer 12 and 14 respectively of a drying section generally designated 16 for drying a web 18 supported by a drying felt 20. The apparatus 10 includes a cylindrical shell generally designated 22.

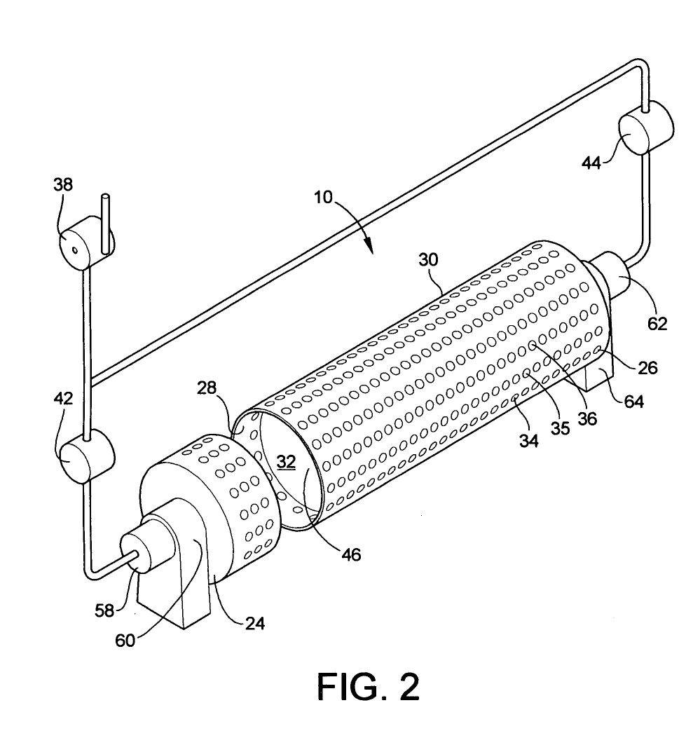

FIG. 2 is a perspective view of the cylindrical shell 22 shown in FIG. 1. As shown in FIG. 2, the shell 22 has a first and a second end 24 and 26 respectively. The shell 22 defines an inner and an outer surface 28 and 30 respectively. The inner surface 28 of the shell 22 defines an elongate enclosure 32 which extends from the first to the second end 24 and 26 respectively of the shell 22. The shell 22 also defines a plurality of holes 34, 35 and 36 with each of the holes 34-36 extending from the inner surface 28 to the outer surface 30 of the shell 22.

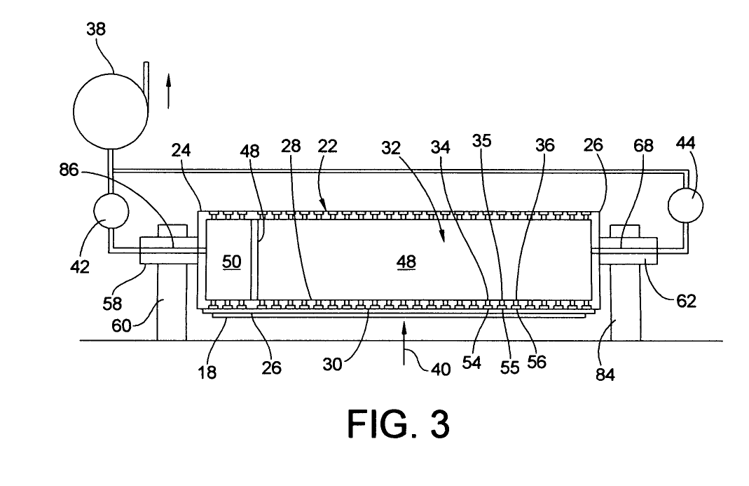

FIG. 3 is a side elevational view of the shell 22 shown in FIGS. 1 and 2. As shown in FIG. 3, the arrangement is such that when the enclosure 32 is connected to a vacuum source 38, air flows, as indicated by the arrow 40, from the web 18 through the felt 20 and through the holes 34-36 into the enclosure 32. Accordingly, the web 18 is urged against the felt 20 and into close conformity with the shell 22 when the web 18 supported by the felt 20 moves as shown in FIG. 1, from the upstream dryer 12 around the shell 22 and onto the downstream dryer 14.

As shown in FIG. 3, the first end 24 of the shell 22 is selectively connected to the vacuum source 38 and a valve 42 is disposed between the vacuum source 38 and the first end 24 of the shell 22 for controlling vacuum applied to the enclosure 32. Also, the second end 26 of the shell 22 is selectively connected to the vacuum source 38 and a further valve 44 is disposed between the vacuum source 38 and the second end 26 of the shell 22 for controlling vacuum applied to the enclosure 32. A baffle 46 is disposed within the enclosure 32 between the first end 24 and the second end 26 of the shell 22 for dividing the enclosure 32 into a main chamber 48 and a threading chamber 50.

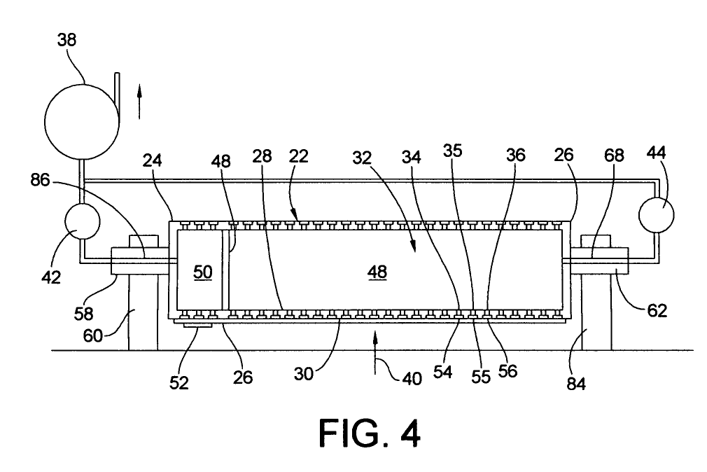

FIG. 4 is a similar view to that shown in FIG. 3. However, FIG. 3 shows how, in operation of the apparatus 10, threading of a tail 52 of the web 18 from the upstream dryer 12 around the shell 22 and onto the downstream dryer 14 is achieved. As shown in FIG. 4, the valve 42 is opened and the further valve 44 is closed so that vacuum is applied within the threading chamber 50 for urging the tail 52 of the web 18 into close conformity with the shell 22 disposed adjacent to the threading chamber 50. When the tail 52 has been threaded, the further valve 44 is opened such that vacuum is applied to both the threading chamber 50 and to the main chamber 48 so that as the tail 52 is widened to a full width of the web 18 as shown in FIG. 3, the fill width of the web 18 is urged into close conformity with the shell 22 between the first and second ends 24 and 26 respectively of the shell 22.

In a more specific embodiment of the present invention, the enclosure 32 is of cylindrical configuration.

As shown in FIGS. 3 and 4, a plurality of circumferential grooves 54, 55 and 56 are defined by the outer surface 30 with each of the grooves 54-56 being spaced axially relative to an adjacent groove.

More specifically, each groove such as groove 54 extends radially inwardly relative to the outer surface 30 of the shell 22 with each groove such as groove 54 being connected to at least one of the holes 34-36 such as hole 34.

Moreover, a first journal 58 is disposed adjacent to the first end 24 of the shell 22 and a first bearing 60 is provided for rotatably supporting the first journal 58. A second journal 62 is disposed adjacent to the second end 26 of the shell 22 and a second bearing 64 is provided for rotatably supporting the second journal 62.

Furthermore, the first journal 58 defines a first conduit 66 which extend from the threading chamber 50 for connecting the threading chamber 50 to the valve 42. Additionally, the second journal 62 defines a second conduit 68 which extend from the main chamber 48 for connecting the main chamber 48 to the further valve 44.

The baffle 46 seals the threading chamber 50 from the main chamber 48, the baffle 46 being of circular disc shaped configuration.

In operation of the apparatus 10 according to the present invention, threading of a tail 52 of the web 18 from the upstream dryer 12 around the shell 22 and onto the downstream dryer 14 is achieved by opening the valve 42 and closing the further valve 44 so that vacuum is applied within the threading chamber 50 for urging the tail 52 of the web 18 into close conformity with the shell 22 disposed adjacent to the threading chamber 50. When the tail 52 has been threaded, the further valve 44 is opened such that vacuum is applied to both the threading chamber 50 and to the main chamber 48 so that as the tail 52 is widened to a full width of the web 18, the full width of the web 18 is urged into close conformity with the shell 22 between the first and second ends 24 and 26 respectively of the shell 22.

The present invention provides a unique arrangement for threading a tail even when access to the dryers and adjacent transfer roll is limited.

What is claimed is:

1. A rotatable vacuum transfer roll apparatus for disposition between an upstream and a downstream rotatable dryer of a drying section for drying a web supported by a drying felt, said apparatus comprising:
a cylindrical shell having a first and a second end, said shell defining an inner and an outer surface, said inner surface defining an elongate enclosure which extends from said first to said second end of said shell, said shell defining a plurality of holes with each of said holes extending between said inner and said outer surface of said shell such that when said enclosure is connected to a vacuum source, air flows from the web through the felt and through said holes into said enclosure for urging the web against the felt and into close conformity with said shell when the web supported by the felt moves from the upstream dryer around said shell and onto the downstream dryer;
said first end of said shell being selectively connected to the vacuum source;
a valve disposed between the vacuum source and said first end of said shell for controlling vacuum applied to said enclosure;
said second end of said shell being selectively connected to the vacuum source;
a further valve disposed between the vacuum source and said second end of said shell for controlling vacuum applied to said enclosure; and
a baffle disposed within said enclosure between said first and second end of said shell for dividing said enclosure into a main chamber and a threading chamber, the arrangement being such that in operation of the apparatus, threading of a tail of the web from the upstream dryer around said shell and onto the downstream dryer is achieved by opening said valve and closing said further valve so that vacuum is applied within said threading chamber for urging the tail of the web into close conformity with said shell disposed adjacent to said threading chamber and when the tail has been threaded, said further valve is opened such that vacuum is applied to both said threading chamber and to said main chamber so that as the tail is widened to a full width of the web, the full width of the web is urged into close conformity with said shell between said first and second ends of said shell.

2. A rotatable vacuum transfer roll apparatus as set forth in claim 1 wherein
said enclosure is of cylindrical configuration.

3. A rotatable vacuum transfer roll apparatus as set forth in claim 1 further including:
a plurality of circumferential grooves defined by said outer surface, each of said grooves being spaced axially relative to an adjacent groove.

4. A rotatable vacuum transfer roll apparatus as set forth in claim 3 wherein
each groove extends radially inwardly relative to said outer surface of said shell with each groove being connected to at least one of said holes.

5. A rotatable vacuum transfer roll apparatus as set forth in claim 1 further including:
a first journal disposed adjacent to said first end of said shell;
a first bearing for rotatably supporting said first journal;
a second journal disposed adjacent to said second end of said shell;
a second bearing for rotatably supporting said second journal.

6. A rotatable vacuum transfer roll apparatus as set forth in claim 5 wherein
said first journal defines a first conduit which extend from said threading chamber for connecting said threading chamber to said valve;
said second journal defines a second conduit which extend from said main chamber for connecting said main chamber to said further valve.

7. A rotatable vacuum transfer roll apparatus as set forth in claim 1 wherein
said baffle seals said threading chamber from said main chamber.

8. A rotatable vacuum transfer roll apparatus as set forth in claim 8 wherein
said baffle is of circular disc shaped configuration.

9. A rotatable vacuum transfer roll apparatus for disposition between an upstream and a downstream rotatable dryer of a drying section for drying a web supported by a drying felt, said apparatus comprising:
a cylindrical shell having a first and a second end, said shell defining an inner and an outer surface, said inner surface defining an elongate enclosure which extends from said first to said second end of said shell, said shell defining a plurality of holes with each of said holes extending from said inner to said outer surface of said shell such that when said enclosure is connected to a vacuum source, air flows from the web through the felt and through said holes into said enclosure for urging the web against the felt and into close conformity with said shell when the web supported by the felt moves from the upstream dryer around said shell and onto the downstream dryer;
said first end of said shell being selectively connected to the vacuum source;
a valve disposed between the vacuum source and said first end of said shell for controlling vacuum applied to said enclosure;
said second end of said shell being selectively connected to the vacuum source;
a further valve disposed between the vacuum source and said second end of said shell for controlling vacuum applied to said enclosure;
a baffle disposed within said enclosure between said first and second end of said shell for dividing said enclosure into a main chamber and a threading chamber, the arrangement being such that in operation of the apparatus, threading of a tail of the web from the upstream dryer around said shell and onto the downstream dryer is achieved by opening said valve and closing said further valve so that vacuum is applied within said threading chamber for urging the tail of the web into close conformity with said shell disposed adjacent to said threading chamber and when the tail has been threaded, said further valve is opened such that vacuum is applied to both said threading chamber and to said main chamber so that as the tail is widened to a full width of the web, the full width of the web is urged into close conformity with said shell between said first and second ends of said shell;
said baffle sealing said threading chamber from said main chamber; and
said baffle being of circular disc shaped configuration.

10. A rotatable vacuum transfer roll apparatus for disposition between an upstream and a downstream rotatable dryer of a drying section for drying a web supported by a drying felt, said apparatus comprising:
a cylindrical shell having a first and a second end, said shell defining an inner and an outer surface, said inner surface defining an elongate enclosure which extends from said first to said second end of said shell, said shell defining a plurality of holes with each of said holes extending from said inner to said outer surface of said shell such that when said enclosure is connected to a vacuum source, air flows from the web through the felt and through said holes into said enclosure for urging the web against the felt and into close conformity with said shell when the web supported by the felt moves from the upstream dryer around said shell and onto the downstream dryer;
said first end of said shell being selectively connected to the vacuum source;
a valve disposed between the vacuum source and said first end of said shell for controlling vacuum applied to said enclosure;
said second end of said shell being selectively connected to the vacuum source;
a further valve disposed between the vacuum source and said second end of said shell for controlling vacuum applied to said enclosure;
a baffle disposed within said enclosure between said first and second end of said shell for dividing said enclosure into a main chamber and a threading chamber, the arrangement being such that in operation of the apparatus, threading of a tail of the web from the upstream dryer around said shell and onto the downstream dryer is achieved by opening said valve and closing said further valve so that vacuum is applied within said threading chamber for urging the tail of the web into close conformity with said shell disposed adjacent to said threading chamber and when the tail has been threaded, said further valve is opened such that vacuum is applied to both said threading chamber and to said main chamber so that as the tail is widened to a full width of the web, the full width of the web is urged into close conformity with said shell between said first and second ends of said shell;
said enclosure being of cylindrical configuration;
a plurality of circumferential grooves defined by said outer surface, each of said grooves being spaced axially relative to an adjacent groove;
each groove extending radially inwardly relative to said outer surface of said shell with each groove being connected to at least one of said holes;
a first journal disposed adjacent to said first end of said shell;
a first bearing for rotatably supporting said first journal;
a second journal disposed adjacent to said second end of said shell;
a second bearing for rotatably supporting said second journal;
said first journal defining a first conduit which extend from said threading chamber for connecting said threading chamber to said valve;
said second journal defining a second conduit which extend from said main chamber for connecting said main chamber to said further valve;
said baffle sealing said threading chamber from said main chamber; and
said baffle being of circular disc shaped configuration.
